(19) United States
(12) Patent Application Publication
(10) Pub. No.: US 2020/0351326 A1
(43) Pub. Date: Nov. 5, 2020

(54) METHOD FOR PROCESSING THE CONTENT OF A FILE LOCATED ON A COMMUNICATION-ENABLED FIRST DATA PROCESSING UNIT ON A COMMUNICATION-ENABLED SECOND DATA PROCESSING UNIT

(71) Applicant: Re2You GmbH, Berlin (DE)

(72) Inventor: Ghazaleh Koohestanian, Berlin (DE)

(21) Appl. No.: 16/932,017

(22) Filed: Jul. 17, 2020

Related U.S. Application Data
(63) Continuation of application No. PCT/EP2019/051014, filed on Jan. 16, 2019.

(30) Foreign Application Priority Data
Jan. 18, 2018 (DE) 10 2018 101 042.7

(51) Int. Cl. H04L 29/08; G06F 3/0486

(52) U.S. Cl. CPC H04L 67/06; G06F 3/0486; H04L 67/141

(57) ABSTRACT

A method for processing the content of a file on a first data processing unit includes presenting the file and a number of contactable data processing units as graphical symbols on a graphical user interface of the first data processing unit, providing a process which enables the processing of the content on a second data processing unit by dragging the graphical symbol representing the file onto the graphical symbol of the second data processing unit selected from the contactable data processing units, wherein the initiation includes establishing a communication contact between the first data processing unit and the selected second data processing unit, transferring the file from the first data processing unit to the selected second data processing unit, defining a number of software applications suitable for processing the content and processing the content on the selected second data processing unit with a selected software application.

### CROSS REFERENCE TO RELATED APPLICATIONS

This application is a continuation application of international patent application PCT/EP2019/051014, filed Jan. 16, 2019, designating the United States and claiming priority to German application 10 2018 101 042.7, filed Jan. 18, 2018, and the entire content of both applications is incorporated herein by reference.

### TECHNICAL FIELD

The present disclosure relates to a method for processing the content of a file located on a communication-enabled first data processing unit equipped with a graphical user interface on a communication-enabled second data processing unit which can be contacted by the first data processing unit via a communication connection.

### BACKGROUND

Communication-enabled data processing units have now become an essential part of daily life. Many people own not only a computer, but also a smartphone, a tablet and a smart TV. In addition, ever-increasing numbers of communication-enabled data processing units are in everyday use. These include, for example, fitness devices, smartwatches and a plurality of devices from the smart home domain. In the smart home domain, smart household devices connected to the Internet, alarm systems and surveillance cameras connected to the Internet and lighting means controllable via WLAN in particular spring to mind.

Many of these devices provide a user interface which enables an operation of the devices. At least some of these devices enable data to be transferred from one device to another. In order to design the file transfer as user-friendly, methods exist which enable a file transfer with a graphical user interface. A method of this type is described, for example, in US 2007/0157101 A1. This published patent application describes the transfer of files from one computer to another computer which is accessed remotely with a drag-and-drop method. The published patent application US 2015/0100615 A1 further describes a method for transferring a resource from one server to another. A graphical interface via which a URI (Uniform Resource Identifier) can be dragged with a drag-and-drop process from an area representing the first server into an area representing the second server is provided here via a user interface which is connected via a communication network to both the first and the second server, as a result of which the resource is transferred from the one server to the other. The drag-and-drop process can also trigger the establishment of a secure communication connection between the servers.

Even if the described drag-and-drop processes enable a certain user-friendliness in the transfer of files between data processing units interconnected in a communication network, this functionality is not sufficient to enable easy working across the data processing units in the case of data processing units which are interconnected via a communication network.

### SUMMARY

It is an object of the present disclosure to simplify working across data processing units with data processing units which are interconnectable in a communication network.

The object is achieved with a method for processing the content of a file located on a communication-enabled first data processing unit equipped with a graphical user interface on a communication-enabled second data processing unit which can be contacted by the first data processing unit via a communication connection as described herein.

The method according to an aspect of the disclosure includes the following steps:
presenting the file with the content to be processed and at least a number of contactable second data processing units as graphical symbols on the graphical user interface of the first data processing unit;
providing a process which enables the processing of the content to be processed on the second data processing unit to be initiated by dragging the graphical symbol representing the file with the content to be processed onto the graphical symbol of a second data processing unit selected from the number of contactable second data processing units, wherein the initiation of the processing of the content to be processed comprises establishing a communication contact between the first data processing unit and the selected second data processing unit;
transferring the file with the content to be processed from the first data processing unit to the selected second data processing unit after establishing the communication contact between the first data processing unit and the selected second data processing unit;
defining in an automated manner a number of software applications suitable for processing the content to be processed and processing the content to be processed on the selected second data processing unit with a software application selected from the number of software applications suitable for processing the content to be processed following the transfer of the file with the content to be processed.

In the context of the present disclosure, a communication-enabled data processing unit is intended to be understood to mean a data processing unit which can be connected via a communication network, e.g., a telecommunication network, the Internet, a WAN (Wide Area Network), a LAN (Local Area Network) or the like to at least one further data processing unit. A communication-enabled data processing unit is also intended to be understood to mean a data processing unit which is formed by a software-defined area of a server which can be connected to a different defined area of the server via a communication connection within the server. As in the case of the segregated server area, the data processing unit itself can be a virtual data processing unit or it can be a physical data processing unit, for example a server, a PC, a notebook, a tablet, a smartphone, a smartwatch, a smart household appliance, a smart fitness device, etc. Generally speaking, any communication-enabled unit which has a graphical user interface can serve as a communication-enabled data processing unit within the meaning of the disclosure. The data processing unit does not necessarily itself need to have suitable output and input units for implementing the graphical user interface. It suffices if the graphical user interface can be presented on a further data processing unit connected to the data processing unit. If the data processing unit is, for example, a virtual server (or other unit without its own output and input units), the graphical user interface of the virtual server can be presented on a tablet, a smartphone, a desktop PC or a notebook connected to the virtual server, for example as a remote desktop. It should also be noted that a graphical user interface is a prerequisite for the first data processing unit, but a graphical user interface of this type is not necessarily required in the case of the second data processing unit.

According to an aspect of the disclosure, a number of contactable second data processing units can even be understood to mean that only one single contactable second data processing unit is present. However, the number of contactable second data processing units typically includes a plurality of contactable second data processing units, i.e., at least two contactable second data processing units. However, the number of contactable second data processing units can also include a large number of contactable second data processing units, for example 20, 100 or even 1000, wherein, with an increasing number of contactable second data processing units, it is advantageous if said second data processing units are combined into groups of second data processing units on the basis of specific criteria, wherein each group can in turn comprise at least one subgroup. In this way, for example, a tree structure of contactable second data processing units can be created which can be useful for locating specific contactable second data processing units on the basis of the specific criteria used to form the groups. Additionally or alternatively, it is possible to provide a search function for the second data processing units with which a search for a specific second data processing unit can be carried out in the number of contactable second data processing units.

A number of software applications suitable for processing the content to be processed is similarly intended to be understood according to the present disclosure to mean that at least one single software application of this type is present. However, the number of software applications suitable for processing the content to be processed can also comprise more than one software application, for example two, three or more software applications. In the case of a large number of software applications, it is furthermore possible to divide the software applications into groups on the basis of specific criteria in order to make it easier for the user to select suitable software on the basis of the specific criteria. These groups can in turn be subdivided into subgroups which are arranged, for example, in the form of a tree structure. Additionally or alternatively, it is possible for the software applications to provide a search function with which a search for a specific software application suitable for processing the content to be processed can be carried out in the number of software application suitable for processing the content to be processed.

The file with the content to be processed can be an executable file, i.e., the content of the file to be processed is executable. In this case, the number of software applications suitable for processing the content to be processed contains those software applications which enable an execution of the executable file. If the executable file is, for example, a file with the change .exe, the suitable software application can contain a program loader. However, the file with the content to be processed can also be a file with displayable and/or processable content, for example an image file, a PDF file, a video file, an audio file, an Office file such as, for example, a Word, Excel or PowerPoint file, etc. The number of software applications suitable for processing the content to be processed then includes those software applications which enable a display of the content to be processed, such as image display software, PDF viewers, Office viewers, etc. Additionally or alternatively, the number of software applications suitable for processing the content to be processed can include a software application enabling an opening of the content to be processed for processing, such as an Office program, a PDF editing program, an audio or video editing program, etc. If the file with the content to be processed is an audio file or video file, the number of software applications suitable for processing a content to be processed can comprise those applications which enable a playing of the audio file or video file, i.e., audio players or video players, etc.

The method according to an aspect of the disclosure makes it easier to work with data processing units which are interconnected or are interconnectable via a communication network insofar as a user simply drags the symbol of the file to be processed by way of a drag-and-drop process onto the symbol of the second data processing unit on which the file is intended to be processed, as a result of which the file is processed in a largely or even totally automated manner on the selected data processing unit. The number of work steps which are required in order to process a file located on a first data processing unit on a second data processing unit connected to the first data processing unit via a communication connection is thereby significantly reduced. The file had hitherto to be transferred from the first data processing unit onto the second data processing unit and the processing of the file then had to be initiated on the second data processing unit itself. This step of initiating the processing of the content of the file on the second data processing unit is eliminated with the method according to an aspect of the disclosure. With the method according to an aspect of the disclosure, it suffices to drag the graphical symbol of the file with the content to be processed onto the graphical symbol of the data processing unit on which the content of the file is intended to be processed in order to trigger the processing, wherein, in a first step, a communication contact is established between the first data processing unit and the selected second data processing unit.

When communication contact is established between the first data processing unit and the selected second data processing unit, a check can be carried out to determine whether a communication connection already exists between the first data processing unit and the selected second data processing unit. If this check reveals that no communication connection has hitherto existed between the first data processing unit and the selected second data processing unit, a communication connection is automatically established between the first data processing unit and the selected second data processing unit. In other words, a standardized protocol is executed to establish a communication connection. The user does not therefore have to concern himself with establishing the communication connection. Instead, the automated establishment of the communication connection is also initiated in this design by dragging the graphical symbol representing the file with the content to be processed onto the graphical symbol representing the selected second data processing unit, as a result of which the working is further simplified. In order to prevent a communication connection from being established with the selected second data processing unit which the user of the second data processing unit does not require, in a further design of the method, the establishment of the communication connection between the first data processing unit and the selected second data processing unit contains a query to the user of the selected second data processing unit asking whether the establishment of a communication connection between the first data processing unit and the selected second data processing unit is accepted. In this case, the communication connection between the first data processing unit and the selected second data processing unit is established only if the user accepts the establishment of the communication connection. Security for the user of the second data processing unit is thereby increased. However, it is also possible for the communication connection to be established without such a query, particularly if both devices have a predefined trust status.

In a further design of the method according to an aspect the disclosure, after the establishment of the contact between the first data processing unit and the selected second data processing unit and before the transfer of the file with the content to be processed to the selected second data processing unit, a query can be sent out to the user of the selected second data processing unit to determine whether a transfer of the file with the content to be processed to the selected second data processing unit is accepted. In this case, the transfer of the file with the content to be processed to the selected second data processing unit takes place only if the user of the selected second data processing unit accepts the transfer of the data with the content to be processed. This further design of the method also increases the security of the user of the second data processing unit. In particular, the risk of malware being transferred unintentionally onto the selected second data processing unit can thereby be reduced. However, it is possible in this design of the method also to dispense with the query to the user, particularly if the transfer of malware onto the selected second data processing unit can otherwise be reliably avoided or both data processing units have a predefined trust status.

It is possible for two or more software applications suitable for processing the content to be processed to be installed on the selected second data processing unit. In this case, during the automated definition of the number of software applications suitable for processing the content to be processed, it is possible to define and display at least two software applications suitable for processing the content to be processed, wherein the display can be presented on either the first data processing unit or the selected second data processing unit. Furthermore, a selection input is enabled with which a user can select a software application from the number of software applications suitable for processing the content to be processed, said selection input then presenting the selected software application. The selection input is enabled on the data processing device on which the software applications suitable for processing the content to be processed are displayed. Instead of displaying the suitable software applications and allowing the selection of the suitable software application to be performed by the user, it is also possible to perform the selection in an automated manner with AI (Artificial Intelligence) software so that the entire method according to an aspect of the disclosure can be carried out without a single interaction with the user.

Although it has hitherto been assumed that, during the automated definition of the number of software applications suitable for processing the content to be processed, the software applications which are defined are those which are installed on the selected second data processing unit, it is additionally or alternatively also possible, during the definition of the number of software applications suitable for processing the content to be processed, to define those software applications which are retrievable via a communication connection, for example via the Internet or via a LAN. In this case, the display of the software applications suitable for processing the content to be processed can contain a grouping of the software applications, for example according to the criteria “free-of-charge use” or “use subject to a charge”. The software applications with use subject to a charge can be further subdivided into those software applications which have to be purchased and those software applications which enable a one-off use on payment of a specific amount without the software applications themselves having to be permanently installed on the second data processing unit.

The automated definition of the number of software applications suitable for processing the content to be processed can be performed on the basis of the file extension of the file with the content to be processed. However, it is also possible for the automated definition of the number of software applications suitable for processing the content to be processed to be performed using AI software. This AI software can also already make a preselection and, for example, only select those software applications which can be used free of charge, or only those software applications which offer a specific functionality scope.

In one special design of the method according to an aspect of the disclosure, the first data processing unit and the at least one contactable second data processing unit are data processing units registered with a server. The contact between the first data processing unit and the second data processing unit is then established via the server, thereby simplifying the establishment of a secure connection between the first data processing unit and the selected second data processing unit. In particular, the server can guarantee a secure connection, and therefore the integrity of the connection, between the first data processing unit and the at least one contactable second data processing unit. The server can furthermore guarantee a trust relationship between the first data processing unit and the at least one contactable second data processing unit via an authentication process if it serves, for example, as a certification body for certificates present on the data processing units.

### BRIEF DESCRIPTION OF THE DRAWINGS

The disclosure will now be described with reference to the drawings wherein:

FIG. 1 shows an exemplary embodiment of a method for processing the content of a file located on a communication-enabled first data processing unit equipped with a graphical user interface on a communication-enabled second data processing unit,

FIG. 2 shows a screen view of a tablet with a graphical symbol which represents a file with content to be processed, and a plurality of graphical symbols which represent contactable second data processing units,

FIG. 3 shows a screen view of a tablet with folders which contain software applications suitable for processing the content of the file to be processed,

FIG. 4 shows a screen view of a tablet in which the folder from the screen view shown in FIG. 3 is opened, and

FIG. 5 shows a screen view of a tablet in which software applications suitable for processing the file to be processed are grouped according to predefined criteria.

### DESCRIPTION OF EXEMPLARY EMBODIMENTS

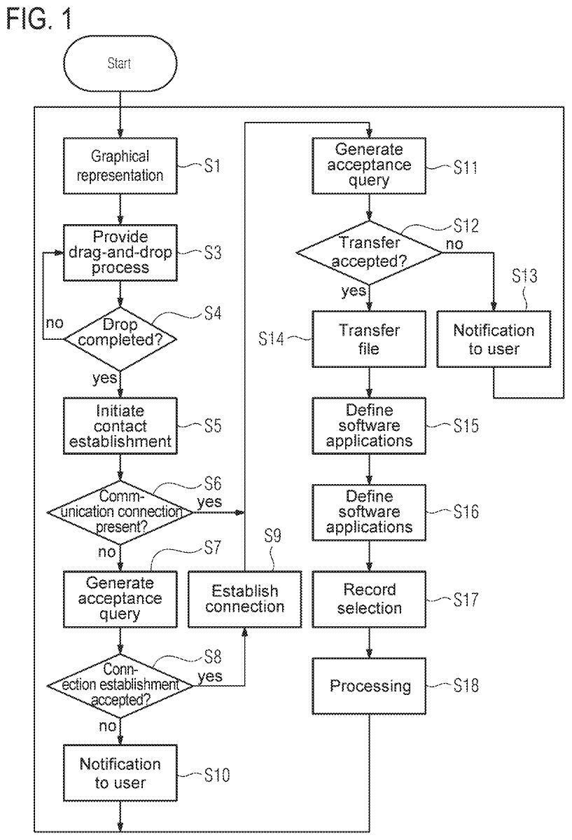

An exemplary embodiment of the method according for processing the content of a file located on a communication-enabled first data processing unit equipped with a graphical user interface on a communication-enabled second data processing unit is described below with reference to the flow diagram shown in FIG. 1. Some of the method steps shown in the flow diagram are only optional and can also be omitted in the method according to the exemplary embodiment of the disclosure.

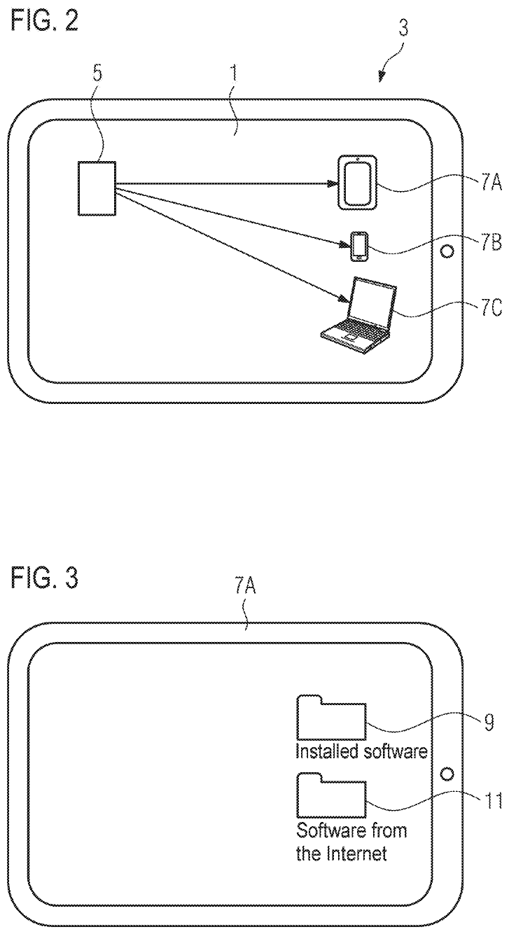

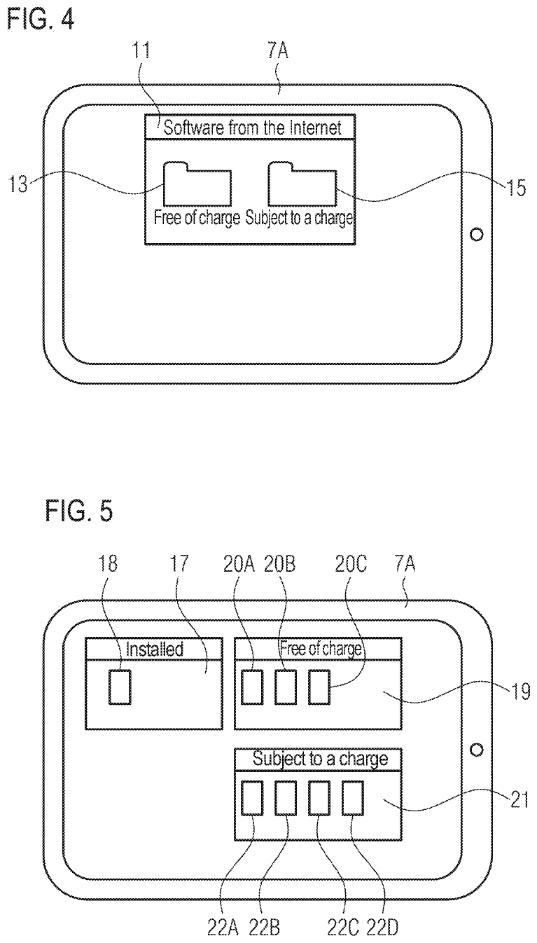

In the present exemplary embodiment, the first data processing unit is a tablet 3 with a touchscreen 1 which represents both the input device and the output device of the tablet 1 (see FIG. 2). However, instead of the tablet 3, the first data processing unit can also be designed as a smartphone, desktop PC, notebook or server which is accessed with a terminal client. Other designs of the first data processing unit are also possible, as long as they are capable of providing a graphical user interface on an input and output device. The data processing unit also does not need to have a touchscreen as an input and output device. Instead, it is also possible, for example, for the data processing device to have a conventional screen as an output device and a keyboard as an input device. The input and output device can be integrated into the data processing unit in the same way as the touchscreen 1 of the tablet 3, or it can be designed as an output and input device separated from the data processing unit, for example as a monitor and keyboard of a desktop PC. However, the design of the input and output device as a separate data processing unit which is connected to the data processing unit providing the graphical user interface for displaying the graphical user interface is also possible, for example as a PC connected to a server or as a tablet, smartphone or the like connected to a server.

The second data processing unit selected in the method typically also has an input device and an output device which may be implemented jointly as a touchscreen, as in the case of the first data processing unit, or separately as a monitor and keyboard or the like. However, the input device and the output device are necessary only if queries are intended to be sent to the user of the second data processing unit according to the method, wherein said user must answer said queries before the method continues. If the entire method is performed in a totally automated manner, an input device and an output device are no longer needed for the selected second data processing unit. In the present exemplary embodiment, the selected second data processing unit is similarly a tablet 7A (see FIG. 3).

Even though touchscreens, monitors and keyboards have been mentioned as input devices and output devices in the present exemplary embodiment, all input devices and output devices which enable the operation of a graphical user interface are essentially suitable.

As already mentioned, a tablet 3 with a touchscreen 1 is used as the first data processing unit in the present example embodiment. The tablet 3 has a graphical user interface which is presented on the touchscreen 1. After the method according to an exemplary embodiment of the disclosure has been started, in step S1 of the method, the graphical user interface presents both a graphical symbol for the file 5 with the content to be processed and graphical symbols for second data processing units 7A, 7B, and 7C contactable by the tablet 3 on the touchscreen 1 of the tablet 3. The graphical user interface with the graphical symbols is shown schematically in FIG. 2. In the present exemplary embodiment, a tablet 7A, a smartphone 7B and a notebook 7C are available as contactable second data processing units. The selection shown in FIG. 2 is obviously intended for illustrative purposes only and does not restrict the possible second data processing units to a tablet, a smartphone, and a notebook.

In step S3, a drag-and-drop process is made available by the method according to the exemplary embodiment of the disclosure to enable the graphical symbol of the file 5 to be dragged onto one of the graphical symbols of the second data processing units 7A, 7B, and 7C and to be dropped there, wherein the drop initiates the establishment of a communication contact between the tablet 3 and the second data processing unit selected from the group of second data processing units 7A, 7B, and 7C. In this drag-and-drop process, a query is performed to determine whether a drop has taken place. If this query in step S4 results in a “no”, the drag-and-drop process is further provided with no action taking place. Conversely, if the query in step S4 results in a “yes”, the method proceeds to step S5 in which the contact establishment with the second data processing unit 7A, 7B, and 7C selected with the drag-and-drop process is initiated. In the present exemplary embodiment, the selected second data processing unit is the tablet 7A.

In the present exemplary embodiment, the initiation of the contact establishment described with reference to step S5 is followed by a check to determine whether or not a communication connection exists to the tablet 7A, i.e., the selected second data processing unit (step S6). If the check reveals that a communication connection does not exist between the tablet 3 and the tablet 7A, the method proceeds to step S7. Conversely, if a communication connection already exists, the method skips steps S7 to S11 to proceed to step S12.

If the method proceeds to step S7, a query is generated in this step which is presented on the tablet 7A as the selected second data processing unit. This query prompts the user of the tablet 7A with an input prompt to indicate whether a connection between the tablet 3 and the tablet 7A is to be established. If the method establishes an input of the user in step S8 indicating that said user does not accept a connection establishment, the method proceeds to step S10 in which a notification is sent to the user of the tablet 3 indicating that the user of the tablet 7A does not accept the establishment of a communication connection. After this notification has been sent, the method returns to step S1. Conversely, if the method establishes an input of the user in step 8 indicating that said user accepts a communication establishment, it proceeds to step S9 in which the connection between the tablet 3 and the tablet 7A is established. The communication can be established according to one of the conventional network protocols, for example via TCP/IP (Transmission Control Protocol/Internet Protocol). However, the present disclosure is not restricted to the use of TCP/IP. Other protocols can similarly be used, in particular proprietary protocols also.

If the communication connection has been established in step S9, the method proceeds to step S11 in which a query is generated and displayed on the touchscreen of the tablet 7A with which the user of the tablet 7A is asked whether he accepts the transfer of the file with the content to be processed. If the method registers an input in step S12 signaling that the user of the tablet 7A does not accept the transfer, the method proceeds to step S13 in which a notification is sent to the tablet 3 indicating that the user of the tablet 7A does not accept the transfer of the file and the method returns to step S1. Conversely, if the user of the tablet 7A accepts the transfer of the file 5 in step S12, the transfer of the file takes place in step S14.

Following the transfer of the file, it is determined in step S15 which software application is suitable or which software applications are suitable for processing the content of the file 5 to be processed. In the present exemplary embodiment, it is assumed that a plurality of software applications, i.e., at least two software applications, are present which are suitable for processing the content of the file 5. These determined software applications are displayed on the touch screen of the second data processing unit 7A in step S16, as shown schematically in FIG. 3. In the exemplary embodiment shown in FIG. 3, the determined software applications are classified according to whether they are software applications installed on the tablet 7A or software applications which can be obtained from the Internet. In the present exemplary embodiment, the software applications installed on the tablet 7A and the software applications to be obtained from the Internet are stored in different folders 9, 11 of the graphical user interface of the tablet 7A. If the user of the tablet 7A wishes to use a software application installed on the tablet 7A for processing the content of the file 5 to be processed, he can open the folder 9 and process the content of the file 5 with one of the software applications contained therein. If no software application suitable for processing the content of the file is installed on the tablet 7A, or the user of the tablet 7A does not wish to use any of the installed software applications suitable for processing the content of the file 5, said user opens the folder 11 with the software applications which are to be obtained from the Internet. In the present exemplary embodiment, this folder in turn contains two subfolders, one of which, i.e., the subfolder 13, contains those software applications which are to be obtained from the Internet free of charge, and the other, i.e., subfolder 15, which contains software applications which are to be obtained from the Internet subject to a charge. Moreover, this subfolder 15 can also contain further subfolders which in each case represent different payment models of the software applications which are to be obtained from the Internet or different price classes of the software applications which are to be obtained from the Internet. It is similarly possible to subdivide the software applications on the basis of their functional scope also. This applies to the installed software applications as well as the software applications which are to be obtained from the Internet. It is essentially also possible for the user to be able to configure. the manner in which the offered software applications are divided.

An alternative option for presenting the software applications suitable for processing the content of the file 5 is shown in FIG. 5. In this view, the software applications are shown in different areas of the display of the tablet 7A, wherein the software applications are combined into groups, for example as shown in FIG. 5, wherein software applications belonging to the same group are surrounded by a border. In FIG. 5, the determined software applications suitable for processing the content of the file 5 are divided into three groups 17, 19, 21, of which the one group, i.e., group 17, contains the software applications installed on the tablet 7A. Although only one software application 18 is shown in FIG. 5 as an installed software application, a plurality of software applications suitable for processing the content of the file 5 are also present and would then similarly be displayed in the area 17. The area 19 in FIG. 5 contains the group of software applications 20A, 20B, and 20C which are to be obtained free of charge from the Internet, and the area 21 contains the group of software applications 22A to 22D which are to be obtained from the Internet subject to a charge. It is obviously also possible here to provide further groups or to divide one of the present groups into two groups. It is thus conceivable, for example, to divide group 21 with the software applications subject to a charge into at least two groups which represent different payment models. It is similarly possible in the variant shown in FIG. 5 to perform a different group division, for example a group division according to the functionality made available by the software applications.

In step S17 of the method according to the exemplary embodiment of the disclosure, the user interface of the tablet 7A enables the user to select one of the presented software applications in order to process the content of the file 5 therewith. In step S18, the content of the file 5 is then processed using the selected software, and the method returns to step S1. Following the processing of the content of the file 5, the file can either remain on the second data processing unit, i.e., on the tablet 7A, or, alternatively, it can be deleted following the processing, as in the case, for example, of a streaming process.

The method according to the exemplary embodiment of the disclosure can be carried out through the mediation of a server or a system including a plurality of servers. If the data processing units which are used are certified on the server or on the server system, it is possible to instigate the establishment of the communication contact between the first data processing unit and the selected second data processing unit via the server. The server can authenticate the participating data processing units and establish a secure connection between the data processing units. The certification further enables a user of the second data processing unit 7A to release certified first data processing units 3 in the method according to the exemplary embodiment of the disclosure, whereupon the inputs provided in step S8 and in step S12 in response to the query concerning the acceptance of the connection establishment or the query concerning the acceptance of the transfer are automatically answered with “yes” without intervention on the part of the user. The number of actions to be performed actively by the user of the second data processing unit 7A can thereby be reduced. Furthermore, if the definition of the software application used to process the content of the file 5 is also automated, the method according to the exemplary embodiment of the disclosure can essentially be carried out completely without interaction with the user of the selected second data processing unit. This becomes possible, for example, if the definition of the software application to be used to process the content of the file 5 is performed by AI software. Software of this type can be based, for example, on a trained neural network. A trained neural network of this type can then select the software suitable for processing the content of the received file and can initiate the processing of the content with this software. Software applications suitable for processing the content of the file can be recognized, for example, by the file extensions. If only one software application is available for processing the content, no further step is to be performed by the AI software. Conversely, if a plurality of software applications are available, it is possible for the AI software to select, from the available software applications, the software which best meets criteria which have been predefined by the user.

A wide range of files can be used as files with the content to be processed, for example audio or video files which are transmitted to the second data processing unit and are played on it. The content of the file is then processed by playing the corresponding final. However, it is also possible that the processing of the content of audio or video files does not consist in playing the files, but in opening the files with a suitable editing program, for example in order to edit a video file. However, the file with the content to be processed may also, for example, be an Office file such as a Word, Excel or PowerPoint file, wherein the processing of the content of the file consists in an opening of the file for editing by the user of the selected second data processing unit. However, the file can also be an executable file, wherein the processing of the content of this executable file on the selected second data processing unit then consists in executing the file.

The disclosure has been described in detail on the basis of an exemplary embodiment for illustrative purposes. However, a person skilled in the art will recognize that departures from the described example embodiment are possible within the scope of the present disclosure and that the disclosure is therefore intended to be limited only by the attached claims.

### LIST OF REFERENCE NUMERALS

1 Touchscreen
3 Tablet
5 File
7A Tablet
7B Smartphone
7C Notebook
9 Folder
11 Folder
13 Subfolder
15 Subfolder
17 Area
18 Software application
19 Area
20A-20C Software application
21 Area
22A-22D Software application

What is claimed is:

1. A method for processing a content of a file located on a communication-enabled first data processing unit equipped with a graphical user interface on a communication-enabled second data processing unit which can be contacted by the first data processing unit via a communication connection, the method comprising:
presenting the file with the content to be processed and at least a number of contactable second data processing units as graphical symbols on the graphical user interface of the first data processing unit;
providing a process which enables the processing of the content to be processed on the second data processing unit to be initiated by dragging the graphical symbol representing the file with the content to be processed onto the graphical symbol of a second data processing unit selected from the number of contactable second data processing units, wherein the initiation comprises establishing a communication contact between the first data processing unit and the selected second data processing unit;
transferring the file with the content to be processed from the first data processing unit to the selected second data processing unit after establishing the communication contact between the first data processing unit and the selected second data processing unit;
defining in an automated manner a number of software applications suitable for processing the content to be processed and processing the content to be processed on the selected second data processing unit with a software application selected from the number of software applications suitable for processing the content to be processed following the transfer of the file with the content to be processed.

2. The method as claimed in claim 1, wherein, when communication contact is established between the first data processing unit and the selected second data processing unit, a check is carried out to determine whether a communication connection already exists between the first data processing unit and the selected second data processing unit and a communication connection is automatically established between the first data processing unit and the selected second data processing unit if the check reveals that no communication connection has hitherto existed between the first data processing unit and the selected second data processing unit.

3. The method as claimed in claim 2, wherein the establishment of the communication connection between the first data processing unit and the selected second data processing unit contains a query to a user of the selected second data processing unit asking whether the establishment of a communication connection between the first data processing unit and the selected second data processing unit is accepted, and the establishment of the connection between the first data processing unit and the selected second data processing unit takes place only if the user accepts the establishment of the network connection.

4. The method as claimed in claim 1, wherein:
after the establishment of the communication contact between the first data processing unit and the selected second data processing unit and before the transfer of the file with the content to be processed to the selected second data processing unit, a query is sent out to the user of the selected second data processing unit to determine whether a transfer of the file with the content to be processed to the selected second data processing unit is accepted, and
the transfer of the file with the content to be processed to the selected second data processing unit takes place only if the user accepts the transfer of the file with the content to be processed.

5. The method as claimed in claim 1, wherein, during the automated definition of the number of software applications suitable for processing the content to be processed at least two software applications suitable for processing the content to be processed are defined and displayed, and a selection input is enabled with which a user can select one from the number of software applications suitable for processing the content to be processed, which then represents the selected software application.

6. The method as claimed in claim 1, wherein, during the automated definition of the number of software applications suitable for processing the content to be processed at least two software applications suitable for processing the content to be processed are defined and displayed, and AI software selects one from the number of software applications suitable for processing the content to be processed, which then represents the selected software application.

7. The method as claimed in claim 1, wherein, during the automated definition of the number of software applications suitable for processing the content to be processed, those software applications are defined which are installed on the selected second data processing unit.

8. The method as claimed in claim 1, wherein, during the automated definition of the number of software applications suitable for processing the content to be processed, those software applications are defined which are retrievable via a communication connection.

9. The method as claimed in claim 1, wherein the automated definition of the number of software applications suitable for processing the content to be processed is performed on the basis of the file extension of the file with the content to be processed.

10. The method as claimed in claim 1, wherein the automated definition of the number of software applications suitable for processing the content to be processed is performed using AI software.

11. The method as claimed in claim 1, wherein the first data processing unit and the at least one contactable second data processing unit are data processing units registered with a server and the establishment of the communication contact between the first data processing unit and the selected second data processing unit runs via the server.

12. The method as claimed in claim 11, wherein the server guarantees a secure connection between the first data processing unit and the at least one contactable second data processing unit.

13. The method as claimed in claim 1, wherein the file with the content to be processed is an executable file and the number of software applications suitable for processing the content to be processed are those software applications which enable an execution of the executable file.

14. The method as claimed in claim 1, wherein the file with the content to be processed is a file with displayable and/or processable content and the number of software applications suitable for processing the content to be processed comprises those software applications which enable a display of the content to be processed and/or an opening of the content to be processed for processing.

15. The method as claimed in claim 1, wherein the file with the content to be processed is an audio or video file and the number of software applications suitable for processing the content to be processed comprises those software applications which enable a playing of the audio or video file.

16. The method as claimed in claim 1, wherein the first data processing unit and the at least one contactable second data processing unit are virtual data processing units located on a server arrangement.
